(19) United States
(12) Patent Application Publication
(10) Pub. No.: US 2010/0113263 A1
(43) Pub. Date: May 6, 2010

(54) NON-PYROPHORIC SHIFT REACTION CATALYST AND METHOD OF PREPARING THE SAME

(75) Inventors: Hyun-chul Lee, Yongin-si (KR); Soon-ho Kim, Seoul (KR); Doo-hwan Lee, Daejeon-si (KR); Yulie Potapova, Yongin-si (KR); Ok-young Lim, Seoul (KR); Eun-duck Park, Incheon-si (KR); Eun-yong Ko, Jeju-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/686,631

(22) Filed: Jan. 13, 2010

Related U.S. Application Data
(62) Division of application No. 11/605,300, filed on Nov. 29, 2006.

(30) Foreign Application Priority Data
Feb. 7, 2006 (KR) 2006-11828

(51) Int. Cl. B01J 23/10

(52) U.S. Cl. 502/304

(57) ABSTRACT

A non-pyrophoric shift reaction catalyst includes an oxide carrier impregnated with platinum (Pt) and cerium (Ce). The non-pyrophoric shift reaction catalyst may be prepared by uniformly mixing a platinum precursor, a cerium precursor, and an oxide carrier in a dispersing medium to obtain a mixture; drying the mixture; and calcining the dried mixture. The shift reaction catalyst having a non-pyrophoric property has an excellent reaction activity even at a low temperature and can efficiently remove carbon monoxide in fuel.

### CROSS-REFERENCE TO RELATED APPLICATIONS

This application is a divisional of U.S. patent application Ser. No. 11/605,300, filed on Nov. 29, 2006, now pending, which claims the benefit of Korean Patent Application No. 10-2006-0011828, filed on Feb. 7, 2006, in the Korean Intellectual Property Office, the disclosures of which are incorporated herein in their entirety by reference.

### BACKGROUND OF THE INVENTION

1. Field of the Invention

Aspects of the present invention relate to a non-pyrophoric shift reaction catalyst and a method of preparing the same. More particularly, aspects of the present invention relate to a non-pyrophoric shift reaction catalyst that has excellent reaction activity even at low temperatures and that can efficiently remove carbon monoxide in fuel, and a method of preparing the same.

2. Description of the Related Art

Fuel cells are electricity generation systems that directly convert the chemical energy of oxygen and hydrogen, such as hydrogen in hydrocarbons such as methanol, ethanol, and natural gas, to electrical energy.

Fuel cell systems consist of a fuel cell stack, a fuel processor (FP), a fuel tank, and a fuel pump. The fuel cell stack is the main body of a fuel cell, and comprises a plurality (several to several tens) of unit cells, each including a membrane electrode assembly (MEA) and a separator (or bipolar plate).

The fuel pump supplies fuel in the fuel tank to the fuel processor. The fuel processor produces hydrogen by reforming and purifying the fuel and supplies the hydrogen to the fuel cell stack. The fuel cell stack receives the hydrogen and generates electrical energy by electrochemical reaction of the hydrogen with oxygen.

A reformer of the fuel processor reforms hydrocarbon fuel using a reforming catalyst. Since a hydrocarbon fuel typically contains one or more sulfur compounds, and since the reforming catalyst can be easily poisoned by sulfur compounds, it is necessary to subject the hydrocarbon fuel to desulfurization prior to the reforming process in order to remove sulfur compounds prior to reforming the hydrocarbon fuel (see FIG. 1).

In hydrocarbon reforming, carbon dioxide (CO₂) and a small quantity of carbon monoxide (CO) are produced, together with hydrogen. Since CO acts as a catalyst poison in electrodes of the fuel cell stack, reformed fuel should not be supplied to the fuel cell stack until CO is removed from the fuel. It is desirable to reduce the CO levels to less than 10 ppm.

CO can be removed by a high temperature shift reaction represented by Reaction Scheme 1 below:

CO+H₂O→CO₂+H₂ <Reaction Scheme 1>

The high-temperature shift reaction is performed at a high temperature of 400 to 500° C. The high-temperature shift reaction can be followed by a low temperature shift reaction at a temperature of 200 to 300° C. Even after a high-temperature shift reaction and a low temperature shift reaction are performed, it is very difficult to reduce the CO levels to less than 5,000 ppm.

To address this problem, a preferential oxidation reaction (referred to as the “PROX” reaction) represented by Reaction Scheme 2 below can be used:

CO+1/2O₂→CO₂ <Reaction Scheme 2>

The high temperature shift reaction and the low temperature shift reaction are reversible reactions depending on temperature. Thus, at low temperatures, the amount of carbon monoxide that can be removed is higher, but the reaction rate of the catalyst is lower. Accordingly, a catalyst that has excellent activity at a low temperature would be advantageous.

Generally, a Cu—Zn based catalyst is used as the shift reaction catalyst at low temperatures. The Cu—Zn based catalyst can start a shift reaction of carbon monoxide at 250° C. or lower, but has a heat resistance temperature of around 300° C. Thus, the reaction heat should not exceed the heat resistance temperature during the shift reaction. Accordingly, the shift reaction needs to be performed slowly in order to retain the activity and stability of the Cu—Zn catalyst. As a result, the reduction process and activation take a long time. In addition, when the starting-up and stopping of the shift reactor is repeated, air flows into the reactor. Since a Cu—Zn based catalyst has a pyrophoric property, it is recommended that inert gas such as N₂ be injected into the reactor to protect the Cu—Zn based catalyst.

### SUMMARY OF THE INVENTION

Aspects of the present invention provide a non-pyrophoric shift reaction catalyst that has an excellent reaction activity even at a low temperature and can efficiently remove carbon monoxide in fuel using its non-pyrophoric property, and a method of preparing the same.

According to an aspect of the present invention, there is provided a non-pyrophoric shift reaction catalyst including an oxide carrier impregnated with platinum (Pt) and cerium (Ce).

According to another aspect of the present invention, there is provided a method of preparing a non-pyrophoric shift reaction catalyst, the method including: uniformly mixing a platinum precursor, a cerium precursor, and an oxide carrier in a dispersing medium; drying the mixture; and calcining the dried mixture.

According to another aspect of the present invention, there is provided a method of preparing a non-pyrophoric shift reaction catalyst, the method including: mixing and heating a carrier precursor in an organic solution containing an acid and ethylene glycol; calcining the mixture to obtain a oxide carrier; wet impregnating a platinum precursor and a cerium precursor into the oxide carrier; drying the impregnated oxide carrier; and calcining the dried impregnated oxide carrier.

According to another aspect of the present invention, there is provided a fuel processor including the non-pyrophoric shift reaction catalyst described above.

According to another aspect of the present invention, there is provided a fuel cell system including the non-pyrophoric shift reaction catalyst described above.

The non-pyrophoric shift reaction catalyst according to aspects of the present invention has an excellent reaction activity even at a low temperature and can efficiently remove carbon monoxide in fuel using its non-pyrophoric property.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic flowchart illustrating fuel processing in a fuel processor used in a conventional fuel cell system;

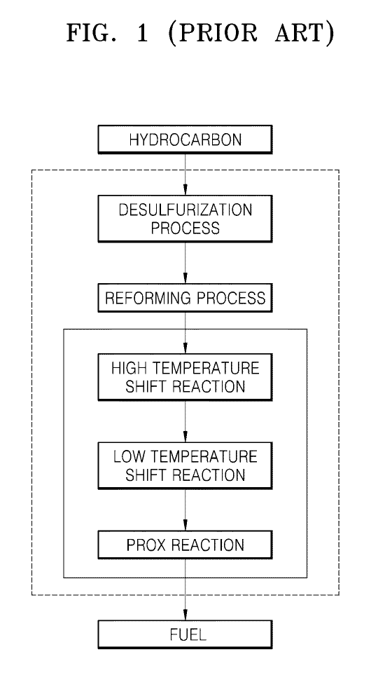

FIG. 2 is a flowchart illustrating the preparation process of a non-pyrophoric shift reaction catalyst according to an embodiment of the present invention;

FIG. 3 is a flowchart illustrating the preparation process of a non-pyrophoric shift reaction catalyst according to another embodiment of the present invention; and

FIG. 4 is a graph illustrating CO concentration and CO conversion with respect to number of cycles, including air injection, of a non-pyrophoric shift reaction catalyst according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

According to an embodiment of the present invention, there is provided a non-pyrophoric shift reaction catalyst including an oxide carrier impregnated with platinum (Pt) and cerium (Ce).

To remove carbon monoxide in fuel supplied to a fuel cell, a shift reaction catalyst should have a non-pyrophoric property for three reasons: first, to provide excellent activity in removing carbon monoxide at 280° C. or lower while still maintaining thermal stability, second, to maintain carbon monoxide conversion rate of at least 90% and provide a carbon monoxide exit concentration of 1% or lower, and third, to allow the fuel cell to operate without nitrogen.

A shift reaction catalyst in which platinum and cerium are impregnated together can satisfy the above descriptions. Hence, the non-pyrophoric shift reaction catalyst according to the current embodiment of the present invention, having excellent performance, can replace a conventional 2-step shift reaction catalyst.

The amount of the platinum according to the current embodiment may be in the range of 0.5 to 10 parts by weight based on 100 parts by weight of the oxide carrier. The amount of the cerium according to the current embodiment may be in the range of 1 to 20 parts by weight based on 100 parts by weight of the oxide carrier. When the amount of the platinum is less than 0.5 parts by weight, the catalyst activity may be insufficient. On the other hand, when the amount of the platinum is 10 parts by weight, the incremental increase in catalyst activity gained by adding additional platinum is small. Therefore, it is uneconomical to provide an amount of platinum greater than 10 parts by weight. When the amount of the cerium is less than 1 part by weight, the contribution of cerium to the catalyst activity may be insufficient. When the amount of the cerium is 20 parts by weight, the incremental increase in catalytic activity is small, and thus, it is uneconomical to provide an amount of cerium greater than 20 parts by weight.

The oxide carrier may be formed of a material selected from the group consisting of γ-alumina (Al₂O₃), TiO₂, ZrO₂, CeO₂, and a mixture thereof, but is not limited thereto.

The specific surface area of the oxide carrier may be in the range of 10 to 1,000 m²/g. When the specific surface area is less than 10 m²/g, the degree of platinum dispersion and impregnation of cerium is too small to provide sufficient catalyst activity. When the specific surface area is greater than 1,000 m²/g, the mechanical properties of the oxide carrier deteriorate.

The average particle size of the platinum may be in the range of 1 to 10 nm. When the average particle size of the platinum is less than 1 nm, the platinum particle size is too small to have sufficient catalyst activity. When the average particle size of the platinum is greater than 10 nm, the platinum particles aggregate, which is disadvantageous for catalyst activity.

Also, when the degree of platinum dispersion is in the range of 60 to 99%, the catalyst activity is optimized.

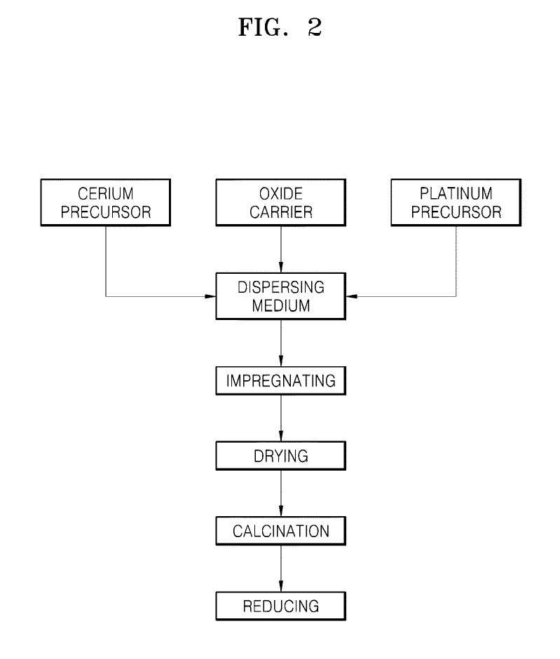

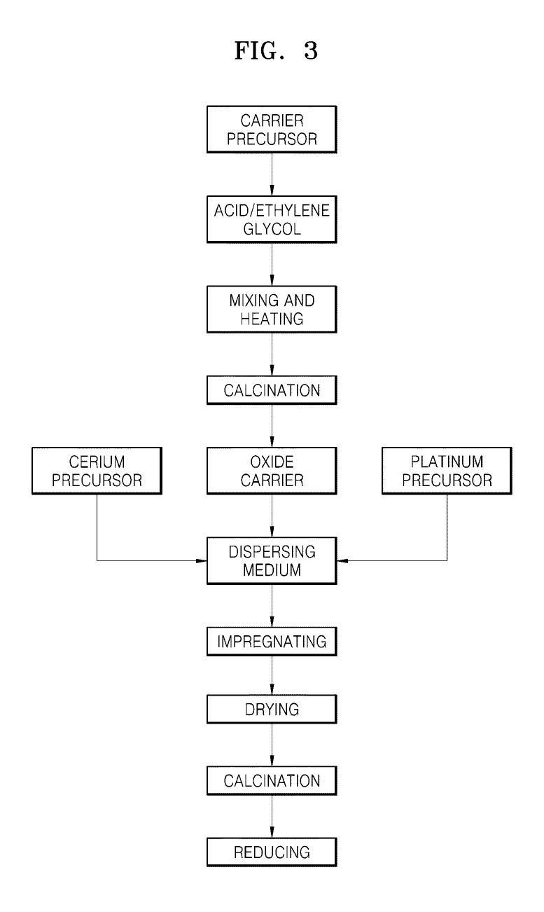

The shift reaction catalyst can be prepared using two separate methods. FIGS. 2 and 3 are flowcharts illustrating preparation processes of a non-pyrophoric shift reaction catalyst according to embodiments of the present invention.

According to an embodiment of the present invention, a method of preparing a non-pyrophoric shift reaction catalyst includes uniformly mixing a platinum precursor, a cerium precursor, and an oxide carrier in a dispersing medium; drying the mixture; and calcining the resultant.

FIG. 2 illustrates a schematic flowchart of the above process. According to the current embodiment of the present invention, the platinum precursor, the cerium precursor, and the oxide carrier are dispersed at the same time to prepare the non-pyrophoric shift reaction catalyst including an oxide carrier impregnated with platinum and cerium.

The platinum precursor, although not limited, may be formed of Pt(NH₃)₄(NO₃)₂, etc. The cerium precursor, although not limited, may be formed of Ce(NO₃)₂.6H₂O, etc. The carrier precursor may be formed of alumina, TiO₂, zirconia (ZrO₂), stabilized zirconia, CeO₂, a mixture thereof, etc.

Methods of uniformly mixing the platinum precursor, the cerium precursor, and the oxide carrier are not specifically limited. For example, a mixture of the platinum precursor, the cerium precursor, and the oxide carrier can be stirred for 1 to 12 hours at a mixing temperature of 40 to 80° C.

During the uniform mixing of the platinum precursor, the cerium precursor, and the oxide carrier, the amount of the platinum precursor may be in the range of 0.5 to 5 parts by weight based on 100 parts by weight of the oxide carrier. The amount of the cerium precursor may be in the range of 1 to 20 parts by weight based on 100 parts by weight of the oxide carrier.

When the amount of the platinum precursor is less than 0.5 parts by weight, the catalyst activity of the non-pyrophoric shift reaction catalyst created by the method described herein may be insufficient. On the other hand, it is uneconomical to provide platinum or a platinum precursor in an amount greater than 5 parts by weight, as noted above. When the amount of the cerium precursor is less than 1 part by weight, the influence of cerium on the catalyst activity of the non-pyrophoric shift reaction catalyst is too small. On the other hand, it is uneconomical to provide cerium or a cerium precursor in an amount greater than 20 parts by weight, as noted above.

The dispersing medium acts as a solvent insofar as it dissolves the platinum precursor and the cerium precursor. However, since it does not dissolve the oxide carrier, it is called the dispersing medium. The dispersing medium is not specifically limited as long as it dissolves the platinum precursor and the cerium precursor, and disperses the oxide carrier. Examples of a dispersing medium include water and an alcohol based solvent. The alcohol based solvent, for example, may be methanol, ethanol, isopropyl alcohol, butyl alcohol, etc., but is not limited thereto.

The mixture is vaporized at 40 to 80° C., for example, and dried to remove the dispersing medium. For example, mixture may be dried at 80 to 120° C. for 6 to 24 hours. The mixture may be dried in a vacuum or in an oven.

After removing the dispersing medium by drying the mixture, the resultant is put into a sealed heating space, such as an oven, to be calcined. The calcination process may be performed at 300 to 700° C. for 2 to 24 hours, for example.

When the temperature is lower than 300° C., the crystal structure of the catalyst is not formed well. When the temperature is greater than 700° C., platinum and cerium particles impregnated in the catalyst grow too large, which reduces the reaction activity of the catalyst. Also, when the calcination process is performed for less than 2 hours, the crystal structure of the catalyst may not be formed sufficiently. On the other hand, it is uneconomical to perform the calcination process for more than 24 hours. The calcination process may be performed in air, but is not specifically limited.

The calcined resultant is reduced to obtain the non-pyrophoric shift reaction catalyst according to the current embodiment of the present invention. For example, the reduction may be performed at 200 to 500° C. for 1 to 12 hours. Also, the reduction may be performed in a hydrogen atmosphere. The reduction atmosphere may further include an inert gas, such as helium, nitrogen, neon, etc.

According to another embodiment of the present invention, a method of preparing a non-pyrophoric shift reaction catalyst includes mixing and heating a carrier precursor in an organic solution containing acid and ethylene glycol; calcining the mixture to obtain an oxide carrier; wet impregnating a platinum precursor and a cerium precursor into the oxide carrier; drying the resultant; and calcining the dried resultant.

FIG. 3 illustrates a schematic flowchart of the above process. According to the current embodiment of the present invention, the carrier precursor is mixed with the organic solution containing acid and ethylene glycol. The mixture is heated and calcined to prepare the oxide carrier having an excellent surface area. Accordingly, the platinum precursor and the cerium precursor are wet impregnated in the oxide carrier.

The carrier precursor may be formed of Al, Ti, Zr, Ce, a mixture thereof, etc., and such a carrier precursor is mixed and heated with the organic solution containing acid and ethylene glycol.

The carrier precursor formed of Al may include at least one material selected from the group consisting of Al(NO₃)₃.9H₂O, AlCl₃, Al(OH)₃, AlNH₄(SO₄)₂.12H₂O, Al(CH₃)₂CHO)₃, Al(CH₃CH(OH)CO₂)₃, Al(ClO₄)₃.9H₂O, Al(C₆H₅O)₃, Al₂(SO₄)₃.18H₂O, Al(CH₃(CH₂)₃O)₃, Al(C₂H₅CH(CH₃)O)₃, and Al(C₂H_{S}O)₃, but is not limited thereto. The carrier precursor formed of Zr may include at least one material selected from the group consisting of ZrO(NO₃)₂, ZrCl₄, Zr(OC(CH₃)₃)₄, Zr(O(CH₂)₃CH₃)₄, (CH₃CO₂)Zr(OH), ZrOCl₂, Zr(SO₄)₂, and Zr(OCH₂CH₂CH₃)₄, but is not limited thereto. The carrier precursor formed of Ti may include at least one material selected from the group consisting of Ti(NO₃)₄, TiOSO₄, Ti(OCH₂CH₂CH₃)₄, Ti(OCH(CH₃)₂)₄, Ti(OC₂H₅)₄, Ti(OCH₃)₄, TiCl₄, Ti(O(CH₂)₃CH₃)₄, and Ti(OC(CH₃)₃)₄, but is not limited thereto. The carrier precursor formed of Ce may include at least one material selected from the group consisting of Ce(NO₃)₃.6H₂O, Ce(CH₃CO₂)₃, Ce₂(CO₃)₃, CeCl₃, (NH₄)₂Ce(NO₃)₆, (NH₄)₂Ce(SO₄)₃, Ce(OH)₄, Ce₂(C₂O₄)₃, Ce(ClO₄)₃, and Ce₂(SO₄)₃, but is not limited thereto.

The acid may be an inorganic acid selected from the group consisting of hydrochloric acid, sulfuric acid, nitric acid, phosphoric acid, and boric acid; or an organic acid selected from the group consisting of citric acid, a C1-C20 aliphatic carboxylic acid, such as, for example, acetic acid and a C1-C30 aromatic carboxylic acid, but is not limited thereto.

Based on 1 part by weight of the oxide carrier, the amount of acid may be 5 to 20 parts by weight and the amount of ethylene glycol may be 10 to 60 parts by weight.

When the amounts of acid and ethylene glycol exceed the above ranges, the calcination process takes a long time. When the amounts of acid and ethylene glycol are below the above ranges, the precursors may not mix well.

The carrier precursor is mixed and heated with the organic solution, and the mixture is calcined to prepare the oxide carrier. For example, the calcination process may be performed at 400 to 700° C. for 2 to 24 hours.

The platinum precursor and the cerium precursor are wet impregnated in the oxide carrier. The amount of the platinum precursor and the cerium precursor based on the oxide carrier may be the same as for the method according to FIG. 2, as described above.

Subsequently, the resultant is dried, then calcined, and then reduced to prepare the non-pyrophoric shift reaction catalyst according to the current embodiment of the present invention. The drying, calcination and reduction may be carried out under the same conditions as described above for the method of FIG. 2. For example, the calcination process may be performed at 300 to 700° C. for 2 to 24 hours.

According to another embodiment of the present invention, a fuel processor including the non-pyrophoric shift reaction catalyst described above is provided. Hereinafter, the fuel processor will be described.

The fuel processor may include a desulfurizer, a reformer, a high temperature shift reaction apparatus, a low temperature shift reaction apparatus, and a PROX reaction apparatus.

The desulfurizer is an apparatus used to remove sulfur-containing compounds that can poison catalysts included in succeeding portions of the fuel processor or in a fuel cell that uses fuel processed by the fuel processor. The desulfurizer may use an adsorber, well known in the related art, to adsorb the sulfur-containing compounds, or may use a hydrodesulfurization process.

The reformer is an apparatus used to prepare hydrogen gas by reforming hydrocarbon supplied as fuel. Catalysts well known in the related art, such as platinum, ruthenium, or nickel, may be used as the reforming catalyst.

The high temperature and low temperature shift reaction apparatuses are apparatuses used to remove carbon monoxide, which can poison catalyst layers of a fuel cell. These apparatuses reduce carbon monoxide concentration to below 1%. The non-pyrophoric shift reaction catalyst of the present invention may be included in the low temperature shift reaction apparatus. The non-pyrophoric shift reaction catalyst, for example, can be fixed inside the low temperature shift reaction apparatus and be charged to be used. Also, the high temperature shift reaction apparatus and the low temperature shift reaction apparatus may be combined as a single shift reaction apparatus. The shift reaction apparatus may be charged with the non-pyrophoric shift reaction catalyst according to aspects of the present invention. Since the non-pyrophoric shift reaction catalyst can excellently remove carbon monoxide, it can be used in a single reaction apparatus.

The PROX reaction apparatus is an apparatus used to reduce the concentration of carbon monoxide to below 10 ppm. The PROX reaction apparatus may be charged with a catalyst well known in the related art.

According to another embodiment of the present invention, there is provided a fuel cell system that includes the non-pyrophoric shift reaction catalyst of the present invention.

The fuel cell system includes a fuel processor and a fuel cell stack. The fuel processor may include a desulfurizer, a reformer, a high temperature shift reaction apparatus, a low shift reaction apparatus, and a PROX reaction apparatus as described above. As described above, the high temperature shift reaction apparatus and the low temperature shift reaction apparatus may combined as a single shift reaction apparatus charged with the non-pyrophoric shift reaction catalyst according to aspects of the present invention. The fuel cell stack can be formed by stacking or disposing a plurality of unit fuel cells, each of which includes a cathode, an anode, and an electrolyte membrane disposed therebetween. The unit fuel cell may further include a separator.

The non-pyrophoric shift reaction catalyst can be included in the fuel processor, and more particularly, included in the shift reaction apparatus.

Hereinafter, aspects of the present invention will be described more specifically with reference to the following Examples. These examples are for illustrative purposes only and are not intended to limit the scope of the present invention.

### Example 1

0.22 g of Pt(NH₃)₄(NO₃)₂, 2.42 g of Ce(NO₃)₂.6H₂O and 10 g of γ-alumina were added to 50 mL of solvent (water), and the mixture was stirred for 6 hours. The mixture was vacuum dried at 60° C. to remove the solvent, then dried in an oven at 110° C. for 16 hours and then calcined at 500° C. for 2 hours in air. Subsequently, the resultant was reduced in the oven at 300° C. for 2 hours in hydrogen atmosphere to prepare Pt—Ce/γ-Al₂O₃.

### Example 2

Pt—Ce/ZrO₂ was prepared in the same manner as in Example 1, except that 10 g of ZrO₂ was used instead of 10 g of γ-alumina.

### Example 3

58.9 g of Al(NO₃)₃.9H₂O was added to a mixed solution of 659.5 g of citric acid and 779.2 g of ethylene glycol. The mixture was stirred at 100° C. for 2 hours, and then heated at 200° C. for 5 hours. Next, the mixture was calcined at 500° C. for 4 hours in air to prepare a γ-Al₂O₃ carrier. Then, 0.22 g of Pt(NH₃)₄(NO₃)₂, 2.42 g of Ce(NO₃)₂.6H₂O 2, and 10 g of γ-Al₂O₃ carrier were added to 50 mL of solvent (water), and stirred for 6 hours to prepare a uniform mixture. The uniform mixture was vacuum dried at 60° C. to remove the solvent, then dried in an oven at 110° C. for 16 hours, and then calcined at 500° C. for 2 hours in air. The resultant was reduced in the oven at 300° C. for 2 hours in hydrogen atmosphere to prepare Pt—Ce/γ-Al₂O₃.

### Example 4

A ZrO₂ carrier was prepared in the same manner as preparing the γ-Al₂O₃ carrier in Example 3, except that 15.0 g of ZrO(NO₃)₂ was mixed with a mixed solution of 136.4 g of citric acid and 161.2 g of ethylene glycol. Then, Pt—Ce/ZrO₂ was prepared in the same manner as in preparing the Pt—Ce/γ-Al₂O₃ in Example 3.

### Example 5

A CeO₂—ZrO₂ carrier was prepared in the same manner as in preparing the γ-Al₂O₃ carrier in Example 3, except that 1.47 g of Ce(NO₃)₃.6H₂O was mixed in a mixed solution of 7.1 g of citric acid and 8.38 g of ethylene glycol, and 12.2 g of ZrO(NO₃)₂ was mixed in another mixed solution of 111.17 g of citric acid and 113.34 g of ethylene glycol. Then, Pt—Ce/CeO₂—ZrO₂ was prepared in the same manner as in preparing Pt—Ce/γ-Al₂O₃ in Example 3.

### Comparative Example 1

Pt/γ-Al₂O₃ was prepared in the same manner as in Example 1, except that Ce(NO₃)₂.6H₂O was not added.

### Comparative Example 2

Pt/ZrO₂ was prepared in the same manner as in Example 2, except that Ce(NO₃)₂.6H₂O was not added.

A shift reaction experiment was performed on the catalysts prepared in Examples 1 through 5 and Comparative Examples 1 and 2. The shift reaction experiment was performed by supplying water with a GHSV (gas hourly space velocity) of 6,000 (hr⁻¹) into gas containing 10 vol % of carbon monoxide, 10 vol % of carbon dioxide, and 80 vol % of hydrogen, wherein the ratio of water and carbon monoxide was 6. The results are shown in Table 1 below.

TABLE 1

| | Reaction | CO Conversion | CO Concentration |
|---|---|---|---|
| | Temperature (° C.) | (%) | (%) |
| Example 1 | 248.30 | 93.21 | 0.57 |
| Example 2 | 248.80 | 93.97 | 0.52 |
| Example 3 | 275.70 | 90.89 | 0.79 |
| Example 4 | 238.00 | 94.43 | 0.47 |
| Example 5 | 266.10 | 94.78 | 0.49 |
| Comparative | 348.70 | 58.77 | 3.87 |
| Example 1 | | | |
| Comparative | 352.00 | 24.37 | 7.34 |
| Example 2 | | | |

As shown in Table 1, the conversion of carbon monoxide in Examples 1 through 5 was at least 90, which is remarkably high compared to Comparative Examples 1 and 2. Also, the reaction temperature in Examples 1 through 5 was less than 280° C., which is remarkably low compared to Comparative Examples 1 and 2.

Also, the surface area and the degree of metal catalyst dispersion impregnated in Examples 1 through 5 and Comparative Examples 1 and 2 were measured. For measurement, argon gas containing 10 vol % of hydrogen was added at 30 sccm (standard cubic centimeters per minute), at 300° C. for 1 hour to reduce the carrier catalyst. Then the degree of dispersion was measured by pulse chemically adsorbing carbon monoxide at 25° C. The surface area was measured using a nitrogen isothermal adsorption method, and the results are shown in Table 2 below.

TABLE 2

| | | Degree of Dispersion |
|---|---|---|
| | Surface Area (m²/g) | (CO mol/Pt mol × 100 density (%)) |
| Example 1 | 143.4 | 72.7 |
| Example 2 | 13.6 | 74.1 |
| Example 3 | 306.1 | 72.6 |
| Example 4 | 54.4 | 86.5 |
| Example 5 | 92.4 | 89.1 |
| Comparative | 142.3 | 56.1 |
| Example 1 | | |
| Comparative | 8.9 | 6.6 |
| Example 2 | | |

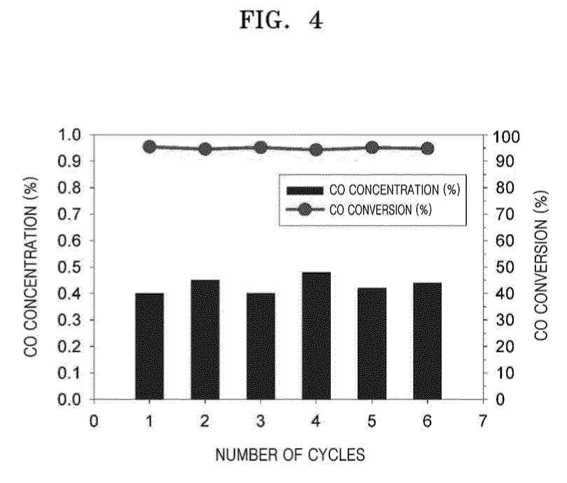

FIG. 4 is a graph illustrating CO concentration and CO conversion with respect to the number of cycles of the non-pyrophoric shift reaction catalyst prepared in Example 4. The CO concentration and the CO conversion were measured by supplying gas containing 10 vol % of carbon monoxide, 10 vol % of carbon dioxide, and 80 vol % of hydrogen with a GHSV of 6,000 (hr⁻¹). After each removal of carbon monoxide, the catalyst was exposed to air at 150° C. in 100 ml/min. Referring to FIG. 4, the non-pyrophoric shift reaction catalyst showed continuously high carbon monoxide removal activity despite the increase in the number of cycles.

The non-pyrophoric shift reaction catalyst according to aspects of the present invention has an excellent reaction activity even at a low temperature and can efficiently remove carbon monoxide in fuel using its non-pyrophoric property.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of preparing a non-pyrophoric shift reaction catalyst, the method comprising:
uniformly mixing a platinum precursor, a cerium precursor, and an oxide carrier in a dispersing medium to obtain a mixture;
drying the mixture; and
calcining the dried mixture.

2. The method of claim 1,
wherein the amount of the platinum precursor is in the range of 0.5 to 5 parts by weight based on 100 parts by weight of the oxide carrier; and
wherein the amount of the cerium precursor is in the range of 1 to 20 parts by weight based on 100 parts by weight of the oxide carrier.

3. The method of claim 1, wherein the oxide carrier is formed of a material selected from the group consisting of alumina, TiO₂, ZrO₂, CeO₂, and a mixture thereof.

4. The method of claim 1, wherein the dispersing medium is selected from the group consisting of water, alcohol, and a mixture thereof.

5. The method of claim 1, wherein the drying of the mixture is performed at 80 to 120° C. for 6 to 24 hours.

6. The method of claim 1, wherein the calcining of the dried mixture is performed at 300 to 700° C. for 2 to 24 hours.

7. A method of preparing a non-pyrophoric shift reaction catalyst, the method comprising:
mixing and heating a carrier precursor in an organic solution containing an acid and ethylene glycol to obtain a mixture;
calcining the mixture to obtain a oxide carrier;
wet impregnating a platinum precursor and a cerium precursor into the oxide carrier;
drying the impregnated oxide carrier; and
calcining the dried impregnated oxide carrier.

8. The method of claim 7, wherein the carrier precursor is selected from the group consisting of an alumina precursor, a Ti precursor, a Zr precursor, a Ce precursor, and a mixture thereof.

9. The method of claim 7, wherein the acid is selected from the group consisting of an inorganic acid selected from the group consisting of hydrochloric acid, sulfuric acid, nitric acid, phosphoric acid, and boric acid; an organic acid selected from the group consisting of citric acid, a C1-C20 aliphatic carboxylic acid and a C1-C30 aromatic carboxylic acid; and a mixture thereof.

10. The method of claim 7, wherein in the mixing and heating of the carrier precursor in the organic solution containing acid and ethylene glycol, the amount of acid is in the range of 5 to 20 parts by weight based on 1 part by weight of the carrier precursor and the amount of ethylene glycol is in the range of 10 to 60 parts by weight based on 1 part by weight of the carrier precursor.

11. The method of claim 7, wherein the calcining of the mixture to obtain the oxide carrier is performed at 400 to 700° C. for 2 to 24 hours.

12. The method of claim 7,
wherein the amount of the platinum precursor impregnated into the oxide carrier is in the range of 0.5 to 5 parts by weight based on 100 parts by weight of the oxide carrier; and
wherein the amount of the cerium precursor impregnated into the oxide carrier is in the range of 1 to 20 parts by weight based on 100 parts by weight of the oxide carrier.

13. The method of claim 7, wherein the drying the impregnated oxide carrier is performed at 80 to 120° C. for 6 to 24 hours.

14. The method of claim 7, wherein the calcining of the dried impregnated oxide carrier is performed at 300 to 700° C. for 2 to 24 hours.
